(19) United States
(12) Patent Application Publication
(10) Pub. No.: US 2026/0213443 A1
(43) Pub. Date: Jul. 23, 2026

(54) CABLE CONNECTOR AND ASSEMBLY THEREOF

(71) Applicant: FOXCONN INTERCONNECT TECHNOLOGY LIMITED, Grand Cayman (KY)

(72) Inventors: KAI-CHIEH YANG, New Taipei (TW); HUNG-CHI YU, New Taipei (TW)

(21) Appl. No.: 19/454,833

(22) Filed: Jan. 21, 2026

(30) Foreign Application Priority Data
Jan. 21, 2025 (CN) 202510096622.7

(51) Int. Cl. H01R 12/75; H01R 12/70; H01R 13/658

(52) U.S. Cl. CPC H01R 12/75; H01R 12/7011; H01R 13/658

(57) ABSTRACT

A cable connector includes an insulator, a row of terminals, a plurality of cables, and a ground plate. The insulator has a mating face. The row of terminals comprises neighboring signal terminals and ground terminals. Each of the cables has two signal wires and a shielding portion exposed at an end thereof. The ground plate is connected to the shielding portion and has a plurality of ground fingers. Each of the row of terminals has a first flat portion and a second flat portion. The signal wires are respectively connected to the second flat portions of the signal terminals. The ground fingers are respectively connected to the second flat portions of the ground terminals. The first flat portions are flatly exposed on the mating face of the insulator.

### BACKGROUND OF THE INVENTION

### Field of the Invention

The present invention relates to a cable connector and an assembly thereof; particularly to a cable connector related to bypass cables. Description of Related Arts

### Description of Related Arts

In conventional data processing and transmission systems, chips such as central processing units (CPUs) or ASICs are mounted on the main circuit board and transmit data to secondary or peripheral components via traces on the board. Given the trend of increasing speed of transmission and decentralization, the use of cables instead of circuit board traces is becoming more prevalent, such as the Co- Packaged Copper (CPC) currently being developed by the OIF. However, the specific design schemes for cable connections between chips and different secondary components are not the same. US Patent No. 9011177 discloses a connection method in which chip components are connected to external I/O connectors via bypass cable elements. The structure of the bypass cable element is also described and shown in detail. However, the cable and terminal structure of the bypass cable element is relatively simple and bulky, making it unsuitable for forming a truly high-speed transmission cable assembly.

### SUMMARY OF THE INVENTION

A cable connector includes an insulator, a row of terminals, a plurality of cables, and a ground plate. The insulator has a mating face. The row of terminals comprises neighboring signal terminals and ground terminals. Each of the cables has two signal wires and a shielding portion exposed at an end thereof. The ground plate is connected to the shielding portion and has a plurality of ground fingers. Each of the row of terminals has a first flat portion and a second flat portion. The signal wires are respectively connected to the second flat portions of the signal terminals. The ground fingers are respectively connected to the second flat portions of the ground terminals. The first flat portions are flatly exposed on the mating face of the insulator.

A cable connector includes a plurality of conductive elements, and a metal frame. Each conductive element has an insulator, a row of terminals, a row of cables, and a ground plate. The insulator has a mating face. The terminals are fixed to the insulator and each have a connection portion and a contact portion exposed on the mating face. The row of terminals includes signal terminals and ground terminals. Each cable has two signal wires and a shielding portion. The signal wires are connected to the connection portions of the corresponding signal terminals. The ground plate has a plurality of ground fingers. The ground fingers are connected to the connection portions of the corresponding ground terminals. The shielding portions are connected to the ground plate. The metal frame has positioning portions bent inward from opposite sides thereof. Each of the positioning portions has a plurality of positioning slots. The ground plate has positioning members extending from both ends thereof. When the conductive elements are inserted into the metal frame, the positioning members are inserted into the corresponding positioning slots and secured by the positioning portions.

An electrical connector assembly includes a cable connector. The cable connector includes an insulator, a row of terminals, a plurality of cables, a ground plate, and a board-end connector. The insulator has a mating face. The row of terminals includes neighboring signal terminals and ground terminals. Each of the cables has two signal wires and a shielding portion exposed at an end thereof. The ground plate is connected to the shielding portion and has a plurality of ground fingers. Each of the row of terminals has a first flat portion and a second flat portion. The signal wires are respectively connected to the second flat portions of the signal terminals. The ground fingers are respectively connected to the second flat portions of the ground terminals. The first flat portions are flatly exposed on the mating face of the insulator. The board-end connector has an insulating body and at least one row of resilient terminals. Each resilient terminal has a resilient contact portion exposed on a top face of the insulating body and a leg portion exposed on a bottom face of the insulating body. The first flat plate portion resiliently presses a corresponding resilient contact portion to achieve an electrical connection.

### BRIEF DESCRIPTION OF DRAWINGS

FIG. 1 shows a perspective view of an electrical connector assembly according to the present disclosure;

FIG. 2 shows a cross-sectional view of the electric connector assembly of FIG. 1 along cut line A-A;

FIG. 3 shows an exploded view of the electrical connector assembly of FIG. 1, comprising a cable connector and a board-end connector;

FIG. 4 show a perspective view of the cable connector of FIG. 3 from another perspective;

FIG. 5 shows a perspective view of a metal frame of FIG. 4;

FIG. 6 shows a partial perspective view of the metal frame of FIG. 5;

FIG. 7 shows an exploded view of the cable connector of FIG. 3;

FIG. 8 shows a perspective view of the conductive elements of FIG. 7;

FIG. 9 shows a perspective view of one of the conductive elements of FIG. 8;

FIG. 10 shows a perspective view of the conductive element of FIG. 9 from another perspective;

FIG. 11 shows an exploded view of the conductive element of FIG. 9;

FIG. 12 shows an exploded view of the ground plate and the terminal module of FIG. 11; and

FIG. 13 shows a perspective view of an electrical connector assembly according to another embodiment of the present disclosure.

### DETAILED DESCRIPTION OF THE DRAWINGS

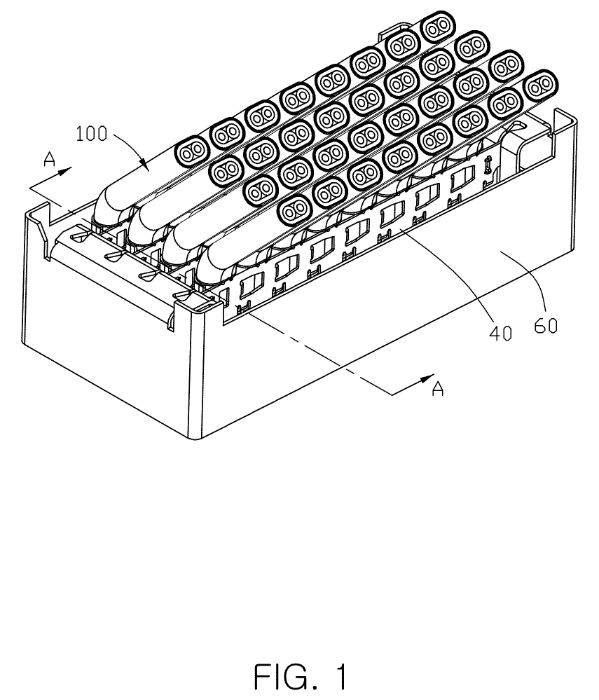

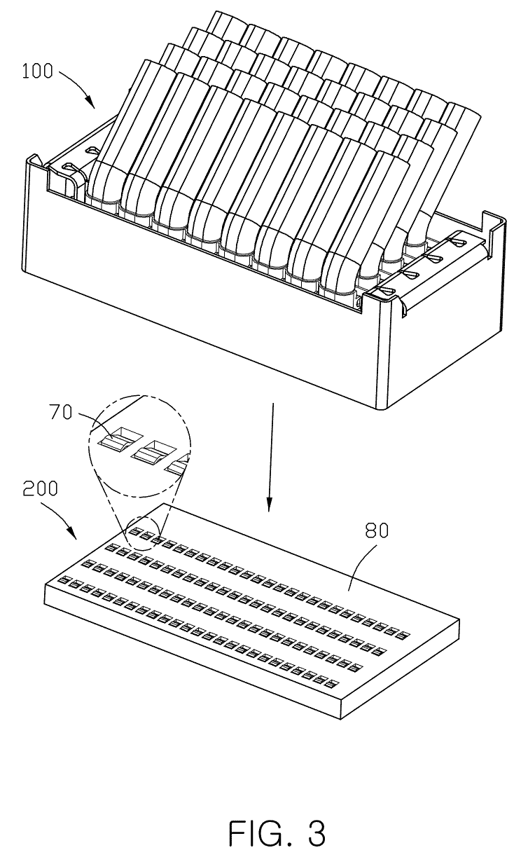

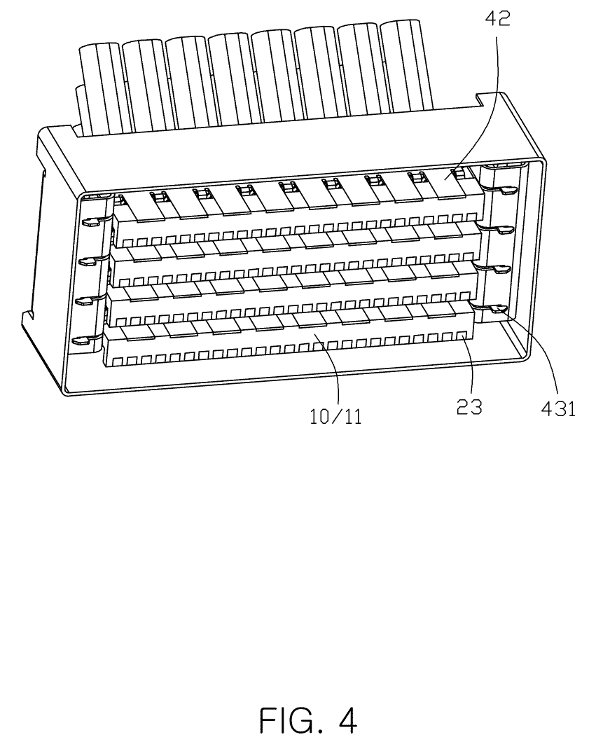

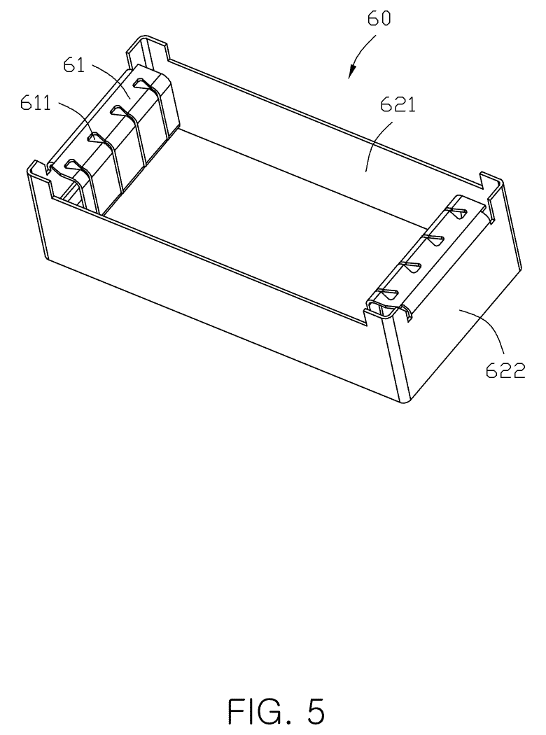

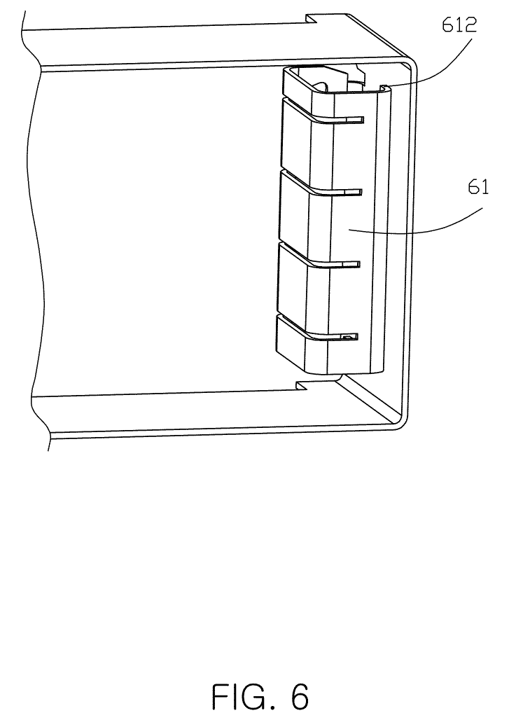

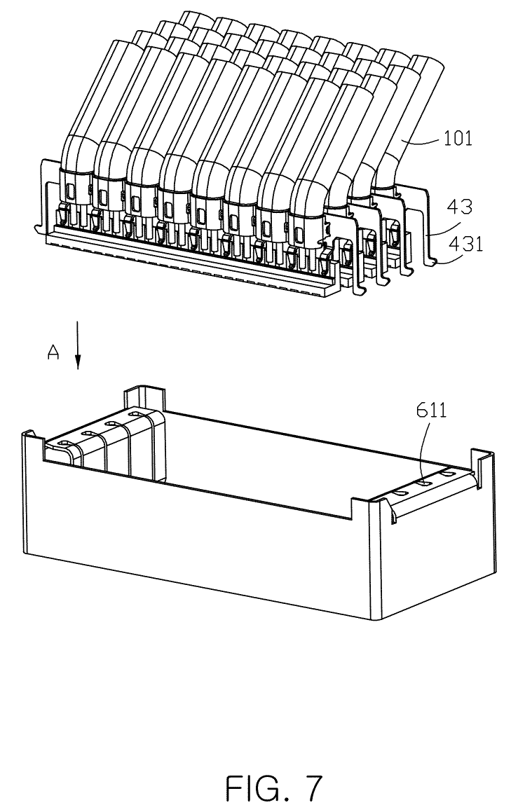

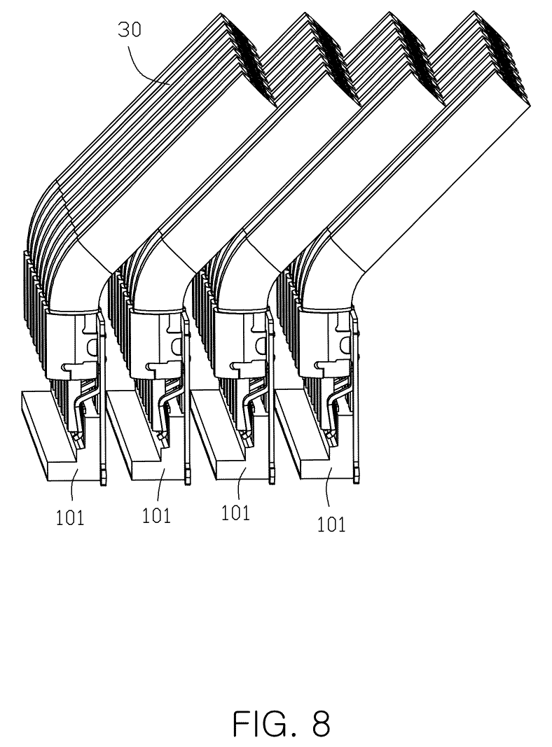

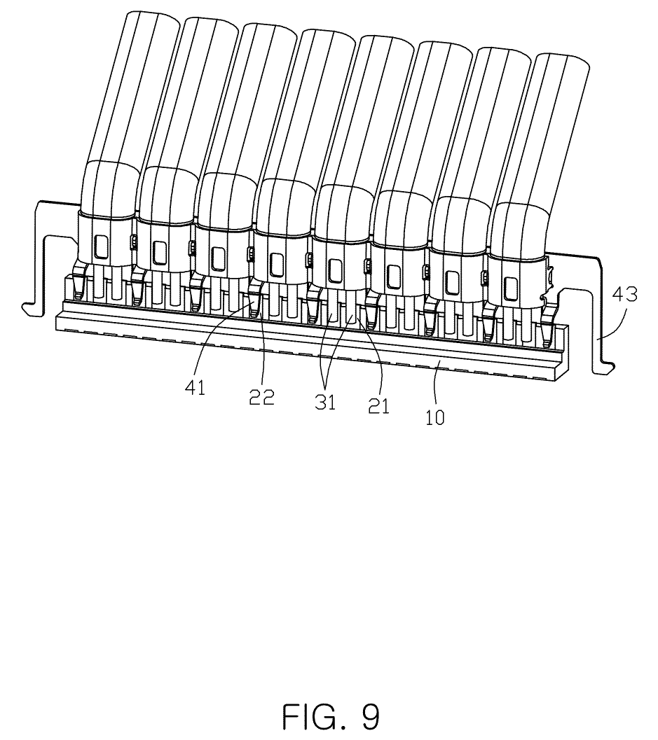

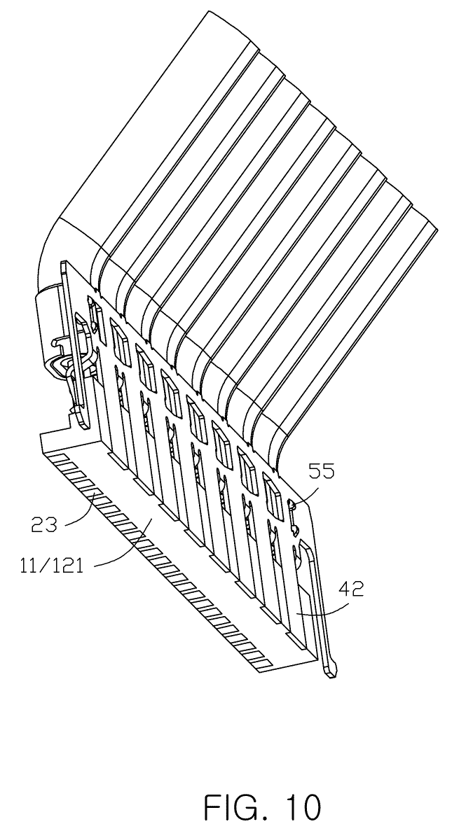

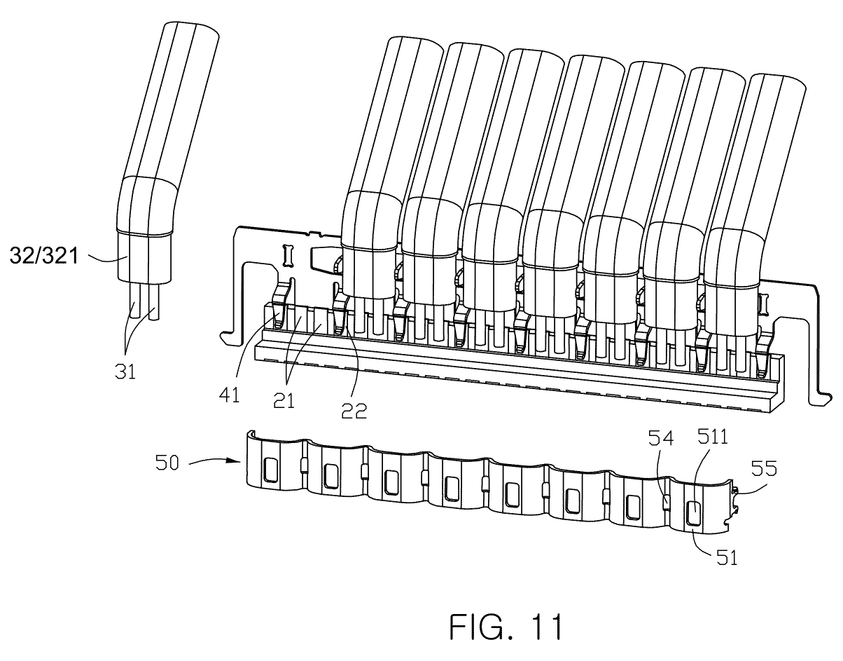

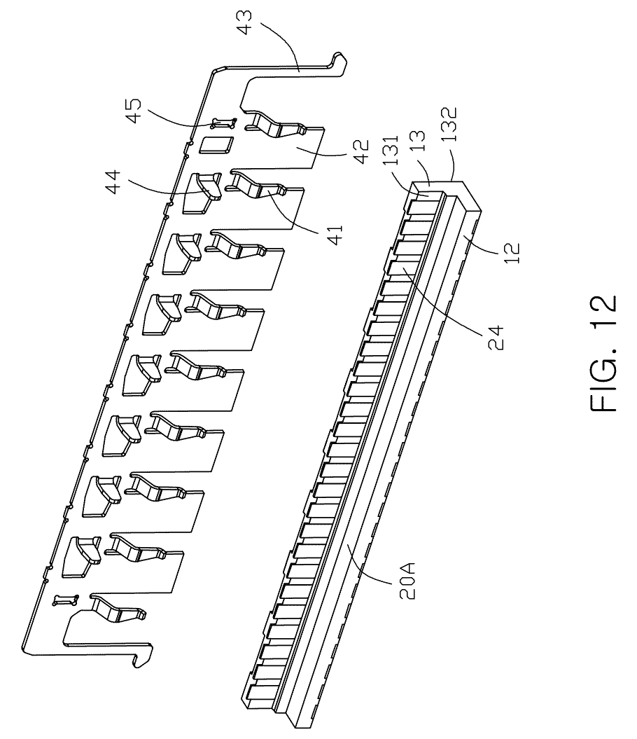

Referring to FIGS. 1-12, the present disclosure discloses an electrical connector assembly, comprising a cable connector 100 and a board-end connector 200 connectable to each other. The board-end connector 200 is typically mounted on a circuit board, such as a motherboard, a subsystem circuit board, or a circuit board substrate in a chip module.

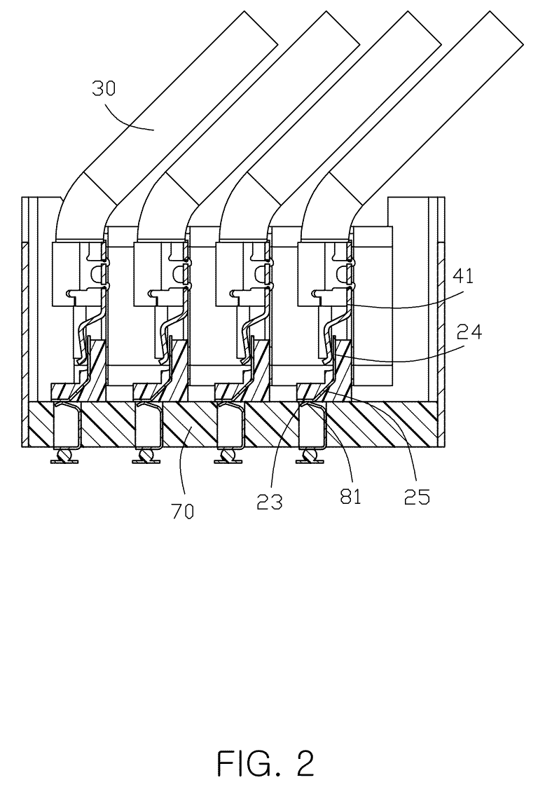

As shown in FIGS. 2-12, the cable connector 100 comprises a plurality of conductive elements 101 arranged in a specific order to form a connector interface array. In some embodiments, four conductive elements 101 are included. Each conductive element 101 includes an insulator 10, a row of terminals 20, a plurality of cables 30, and a ground plate 40. The insulator 10 has a mating face 11. The row of terminals 20 includes adjacent signal terminals 21 and a ground terminal 22. Each terminal 20 includes a first flat portion 23 and a second flat portion 24. The first flat portion 23 is flatly exposed on the mating face 11 of the insulator 10. Two signal wires 31 and a shielding portion 32 are exposed at an end of each cable 30. The ground plate 40 connects to the shielding portion 32 and a plurality of ground fingers 41 extend from the ground plate 40. The signal wires 31 respectively connect to the second flat portions 24 of the signal terminals 21, and the grounding fingers 41 respectively connect to the second flat portions 24 of the ground terminals 22. A mating interface for a cable connector is thus created, which is flat, and non-flexible.

Specifically, the insulator 10 is generally L-shaped, including an elongated horizontal portion 12 and an elongated vertical portion 13. The bottom face 121 of the horizontal portion 12 forms the mating face 11. The first flat portion 23 lies flat on the bottom face 121 of the horizontal portion, and the second flat portion 24 lies flat on the front face 131 of the vertical portion 13. In the present embodiment, the front face 131 is perpendicular to the bottom face 121. Thus, the cable connector 100 is perpendicularly connected to the board-end connector 200. Referring to FIG. 2, each terminal 20 includes an inclined portion 25 connecting the first flat portion 23 and the second flat portion 24. The inclined portion 25 is embedded in the insulator 10. Viewed from the side, the first flat portion 23 is positioned in front of a corresponding second flat portion 24. The insulating material is fixed to the row of terminals 20 by injection molding, thereby forming a terminal module 20A.

Each cable 30 further includes an insulating layer (not shown) surrounding the two signal wires 31. The shielding portion 32 is a shielding layer 321 surrounding the insulating layer. The ground plate 40 is an elongated plate, and the shielding layer 321 abuts the ground plate 40.

The conductive element 101 further includes a ground clamp 50. The ground clamp 50 is fixed to the ground plate 40 and clamps the cables 30 therebetween. The ground clamp 50 includes a plurality of arched portions 51. The cables 30 respectively pass through the arched portions 51 and are clamped on the other side by the ground plate 40. The ground plate 40 is an elongated plate-like structure.

The ground fingers 41 are formed by stamping and bending one side of the ground plate 40, and each ground finger 41 is a bent and resilient structure. Extensions 42 are formed between the ground fingers 41, and the extensions 42 are positioned on a same plane as the ground plate 40 is, and are not bent. Positioning members 43 extend from two ends of the ground plate 40, and the positioning members 43 are L-shaped. The ground clamp 50 has attachment portions 55 at both ends thereof. The attachment portions 55 pass through attachment holes 45 on the ground plate 40 for attachment. At the same time, a plurality of ear members 44 are stamped out of the ground plate 40, and the ear members 44 pass through one side of the cable 30 and are fixed in retaining holes 54 positioned between neighboring arched portions of the ground clamp 50.

In the present embodiment, the row of terminals 20 is fixed in the insulator 10 by injection molding to form the terminal module 20A. Then, the ground plate 40 is placed horizontally, and the terminal module 20A is installed on the ground plate 40 at a certain angle. A rear face 132 of the vertical portion 13 contacts a front face 46 of the ground plate 40, and the ground fingers 41 press resiliently against the corresponding second flat portions 24 of the ground terminals 22. The extensions 42 respectively engage the shallow recesses formed on the rear face 132 of the insulator 10, thereby properly positioning the terminal module 20A on the ground plate 40. Subsequently, the exposed ends of the row of cables 30 are positioned on the second flat portions 24 of the signal terminals 21, and then the signal wires 31 are soldered to the second flat portions 24 of the signal terminals 21, and the ground fingers 41 are soldered to the second flat portions 24 of the ground terminals 22. The arched portions 51 each have an opening 511 to facilitate soldering. The ground plate 40 not only provides grounding but also acts as a shield. The ground plate 40 is relatively large and supports the entire terminal module 20A. Next, the ground clamp 50 is installed on the front of the shielding layers 321 and fixed, and further welding can be performed for further fixing the ground clamp 50. In the present embodiment, the ground plate 40 not only matches the row of terminals 20 in the longitudinal direction, but also has a larger width in the vertical direction. After the ground fingers 41 are cut and formed, the remaining portion forms the extensions 42. The extensions 42 shield the terminals 20 and the signal wires 31 in the vertical directions, thus providing a good shielding effect against neighboring conductive components.

The cable connector includes a metal frame 60. The metal frame 60 includes positioning portions 61 bent inwards from opposite sides. Each positioning portion 61 has a plurality of positioning slots 611. When the conductive element 101 is inserted into the metal frame 60, the positioning members 43 are respectively inserted into the positioning slots 611 and secured to the positioning portion 61. The end of the cable is arranged vertically and the cable extends therefrom at an angle. In the present embodiment, the metal frame 60 has a rectangular structure formed by two long sidewalls 621 and two short sidewalls 622. The positioning portion 61 has a metal plate bending horizontally inwards from the top edge of the short sidewall 622, then bends vertically downwards, then bends horizontally outwards, and finally, an end 612 is soldered and fixed to the inner wall face of the short sidewall 622. In the present disclosure, the metal frame 60 formed by a metal plate separates and accommodates the conductive elements. The ground plate 40, in addition to serving as a soldering support, is also assembled to the metal frame 60, providing positioning and separation functions, and increasing the signal impedance shielding effect. In the present disclosure, insulating material can be injection molded onto the outer side of each conductive element 101 to form an independent cable connector. Such cable connectors can be inserted into the positioning slots 611 of the metal frame 60 respectively. Alternatively, insulating material can be injection molded onto the outer sides of the conductive elements 101 to form a single cable connector, which is then inserted into the metal frame 60. The first flat portion 24 has a contact portion for mating, and the second flat portion has a connection portion for connecting with the cable and a connection portion for contacting the ground plate 40. The ground plate 40 not only serves as a shield at the connection portion between the signal wire and the cable, but also provides additional functions such as support and locking. In summary, the cable connector includes a plurality of conductive elements and a metal frame. Each conductive element includes an insulator, a row of terminals, a row of cables, and a ground plate. The insulator has a mating face. The terminals are fixed to the insulator and have contact portions exposed on the mating face and connection portions. The row of terminals includes signal terminals and ground terminals. Each cable includes a pair of signal wires and a shielding portion. Each signal wire is connected to a connection portion of a corresponding signal terminal. The ground plate has multiple ground fingers. Each ground finger is connected to a connection portion of a corresponding ground terminal. The shielding portion is connected to the ground plate. The metal frame includes positioning portions bent inward from opposite sides. Each positioning portion has a plurality of positioning slots. Positioning portions extend from both ends of the ground plate. When a conductive element is inserted into the metal frame, the positioning portions are inserted into corresponding positioning slots and held in place by the positioning portion.

The board-end connector 200 includes a plate-shaped insulating body 70 and a plurality of rows of resilient terminals 80. The insulating body 70 has a horizontal top face 71. Each resilient terminal 80 includes a resilient contact portion 81 exposed on the top face 71 of the insulating body 70 and a leg portion 82 exposed on the bottom face of the insulating body 70. The leg portion 82 can be soldered onto a circuit board. When the cable connector 100 mates with the board-end connector 200, the first flat portion 23 resiliently abuts the corresponding resilient contact portion 81, forming an electrical connector.

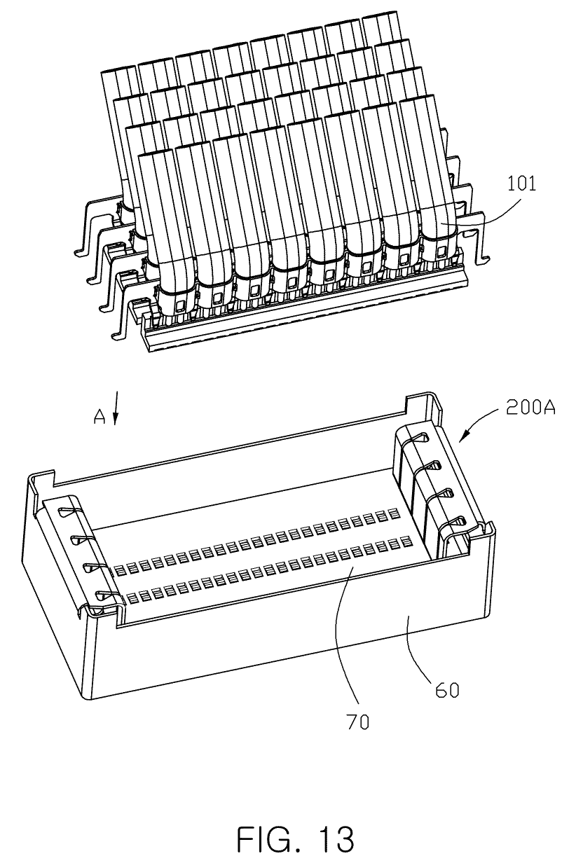

FIG. 13 shows a modified electrical connector assembly having a metal frame 60 arranged on the board-end connector 200A. The metal frame 60 surrounds an insulating body 70 and extends upward beyond the top surface 71 of the insulating body. The metal frame 60 includes positioning portions bent inward from opposite sides. Each positioning portion has a plurality of positioning slots. The positioning portions extend from both ends of a ground plate. When the cable connector is inserted into the metal frame 60, the positioning portions are inserted into the corresponding positioning slots and secured to the positioning portions.

The above embodiments are preferred embodiments of the present disclosure, but not all embodiments. Any equivalent changes to the present disclosure made by a person skilled in the art through reading the present disclosure are covered by the claims of the present disclosure.

1. A cable connector comprising:
an insulator;
a row of terminals;
a plurality of cables; and
a ground plate;
wherein the insulator has a mating face, the row of terminals comprises neighboring signal terminals and ground terminals, each of the cables has two signal wires and a shielding portion exposed at an end thereof, the ground plate is connected to the shielding portion and has a plurality of ground fingers, each of the row of terminals has a first flat portion and a second flat portion, the signal wires are respectively connected to the second flat portions of the signal terminals, the ground fingers are respectively connected to the second flat portions of the ground terminals, and the first flat portions are flatly exposed on the mating face of the insulator.

2. The cable connector according to claim 1, wherein the insulator comprises a horizontal portion and a vertical portion, the mating face is arranged on the bottom face of the horizontal portion, and the second flat plate portion is exposed on the front face of the vertical portion.

3. The cable connector according to claim 1, wherein each cable further comprises an insulating layer surrounding the two signal wires, the shielding portion is a shielding layer surrounding the insulating layer, the ground plate is an elongated plate, and the shielding layer abuts the ground plate.

4. The cable connector according to claim 3, further comprising a ground clamp, and wherein the grounding clamp has a plurality of arched portions for the cables to pass through, and the ground clamp is fixed to the ground plate and the cables are clamped between the ground clamp and the ground plate.

5. The cable connector according to claim 4, wherein the ground clamp has attachment portions at two ends thereof, the attachment portions pass through attachment holes provided on the ground plate, the ground plate has a plurality of ear members, the ear members pass through one side of the cable and are fixed to retaining holes between neighboring arched portions of the ground clamp plate.

6. The cable connector according to claim 5, wherein the ground plate is attached to the rear face of the vertical portion.

7. The cable connector according to claim 4, further comprising a metal frame, and wherein the metal frame comprises positioning portions bent inward from opposite sides thereof, each of the positioning portion has a plurality of positioning slots, the ground plate has positioning members extending from two ends thereof, and the positioning members are respectively insertable into the positioning slots to be secured to the positioning portions.

8. The cable connector according to claim 1, wherein each of the terminals has an inclined portion connecting the first flat portion and the second flat portion thereof, the inclined portion is embedded in the insulator, and the first flat portion is located in front of the second flat portion.

9. A cable connector comprising:
a plurality of conductive elements; and
a metal frame; wherein
each conductive element has an insulator, a row of terminals, a row of cables, and a ground plate, the insulator has a mating face, the terminals are fixed to the insulator and each have a connection portion and a contact portion exposed on the mating face, the row of terminals comprises signal terminals and ground terminals, each cable has two signal wires and a shielding portion, the signal wires are connected to the connection portions of the corresponding signal terminals, the ground plate has a plurality of ground fingers, the ground fingers are connected to the connection portions of the corresponding ground terminals, the shielding portions are connected to the ground plate, the metal frame has positioning portions bent inward from opposite sides thereof, each of the positioning portions has a plurality of positioning slots, the ground plate has positioning members extending from both ends thereof, and when the conductive elements are inserted into the metal frame, the positioning members are inserted into the corresponding positioning slots and secured by the positioning portions.

10. An electrical connector assembly comprising:
a cable connector comprising:
an insulator;
a row of terminals;
a plurality of cables; and
a ground plate;
wherein the insulator has a mating face, the row of terminals comprises neighboring signal terminals and ground terminals, each of the cables has two signal wires and a shielding portion exposed at an end thereof, the ground plate is connected to the shielding portion and has a plurality of ground fingers, each of the row of terminals has a first flat portion and a second flat portion, the signal wires are respectively connected to the second flat portions of the signal terminals, the ground fingers are respectively connected to the second flat portions of the ground terminals, and the first flat portions are flatly exposed on the mating face of the insulator; and
a board-end connector having an insulating body and at least one row of resilient terminals, wherein each resilient terminal has a resilient contact portion exposed on a top face of the insulating body and a leg portion exposed on a bottom face of the insulating body, and the first flat plate portion resiliently presses a corresponding resilient contact portion to achieve an electrical connection.

11. The electrical connector assembly as claimed in claim 10, wherein the board-end connector has a metal frame surrounding the insulating body and extending upward beyond the top face of the insulating body, the metal frame has positioning portions bent inward from opposite sides thereof, each of the positioning portions has a plurality of positioning slots, the ground plate has positioning members extending from both ends thereof, and when the cable connector is inserted into the metal frame, the positioning members are inserted into the corresponding positioning slots and secured by the positioning portions.
